(19) United States
(12) Patent Application Publication
(10) Pub. No.: US 2005/0102347 A1
(43) Pub. Date: May 12, 2005

(54) Medium hopping across networks

(75) Inventors: Robert C. Knauerhase, Portland, OR (US); Du V. Nguyen, Tigard, OR (US)

Correspondence Address: VENABLE, BAETJER, HOWARD AND CIVILETTI, LLP, P.O. BOX 34385, WASHINGTON, DC, 20043-9998, US

(73) Assignee: Intel Corporation, Santa Clara, CA (US)

(21) Appl. No.: 10/703,430

(22) Filed: Nov. 10, 2003

(51) Int. Cl. G06F 15/16

(52) U.S. Cl. 709/200

(57) ABSTRACT

Interfacing an application running on one device with a destination device may include using a pseudo-connection to the application within the device and coupling the pseudo-connection to a real-network connection.

### BACKGROUND OF THE INVENTION

Mobile devices, such as mobile telephones, personal digital assistants (PDAs), and paging devices, have become ubiquitous in the world today. In our fast-paced society, we rely on such devices to give us greater flexibility in our daily lives, for business, family, and pleasure. With the proliferation of mobile network devices has come a proliferation of mobile networks.

With advances in network technologies come upgrades to networks. So, too, with different types of network communications (e.g., voice, facsimile, data), different types of network connections may exist within a particular network. Additionally, a particular mobile device may be capable of connecting to multiple networks and multiple different types of network connections within a single network. In traversing a network or networks, therefore, it is possible that a user will switch among various connections of various speeds and qualities of service and types.

Some wireless networks today permit switching between cells of the same network (e.g., from one cell to another), but the switching operation is not always transparent to the user application. It is also possible in many networks to have a multi-network mobile device (e.g., a multi-mode mobile telephone), but switching among networks is generally apparent to the end server. For example, the application and/or the server may need to address disruptions in service during switching operations. Furthermore, with, for example, IP networks, the server connection is generally re-established using a new network address, which may cause disruptions to be apparent.

Additionally, different connections within networks or in different networks may have different characteristics, for example, speed, latency, cost, or other factors or combinations of factors. As a result, not all connections may provide equivalent performance.

### BRIEF DESCRIPTION OF THE DRAWINGS

Preferred embodiments of the invention will now be described in connection with the associated drawings, in which:

FIG. 1 depicts a conceptual block diagram of a system implementing an embodiment of the invention;

FIG. 2 depicts a conceptual block diagram of a mobile device according to an embodiment of the invention;

FIG. 3 depicts a flowchart of a method implementing an embodiment of the invention; and

FIG. 4 depicts a block diagram of a further embodiment of the invention.

### DETAILED DESCRIPTION OF PREFERRED EMBODIMENTS

In the following description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the term “coupled,” along with its derivatives, may be used. It should be understood that “coupled” may mean that two or more elements are in direct physical or electrical contact with each other or that the two or more elements are not in direct contact but still cooperate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

For the purposes of this disclosure, and in the appended claims, unless otherwise stated, a “connection” is not used to refer to a physical layer connection; rather, it refers to connection at least at the network layer (or higher) of the Open System Interconnect (OSI) protocol model. Examples of such connections include Internet Protocol (IP) sockets, logical connections, virtual connections, and other such types of higher-level connectivity.

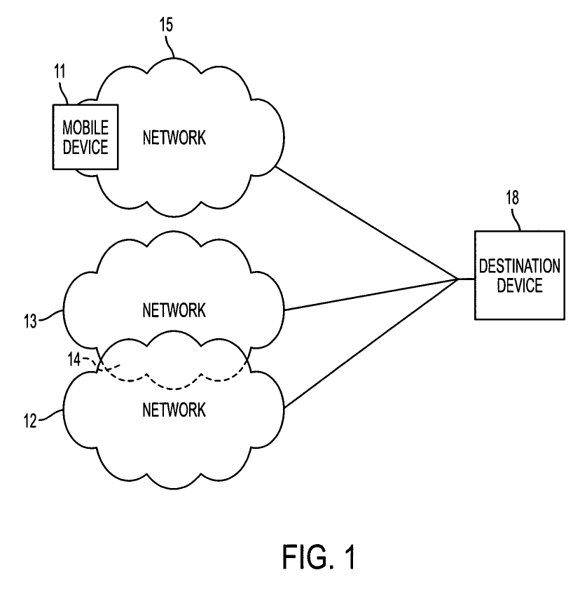

FIG. 1 depicts a system in which the present invention may be implemented. A mobile device 11 may run an application that requires communication with a destination device 18. The mobile device 11 may be capable of connecting to a number of networks 12, 13, 15. As shown, there may be regions in which the coverage areas of two or more networks overlap, e.g., the region denoted by reference numeral 14. Other networks, e.g., that denoted by reference numeral 15, may include multiple communication media. As mobile device 11 is moved from one location to another, the network or networks via which mobile device 11 may be capable of communicating may change. As a result, the actual routing of communications between the mobile device 11 and the destination device 18 may change.

Note that the network or networks with which a device may be capable of communicating may also occur as a result of changes within a network occurring while the device remains stationary (for example, but not limited to, a network being brought up or down). Hence, although the disclosure and claims refer to a “mobile device,” it is to be understood that it may also be applicable to at least some stationary devices, and therefore, “mobile device” may be not just a device that is actually moved, but also a stationary device for which network conditions may change.

In order to make a change in routing appear as seamless as possible to an application running on mobile device 11, mobile device 11 may be implemented using a communications subsystem. The communications subsystem may function to make it appear to the application that there has been no break in connectivity, even when such a break actually occurs.

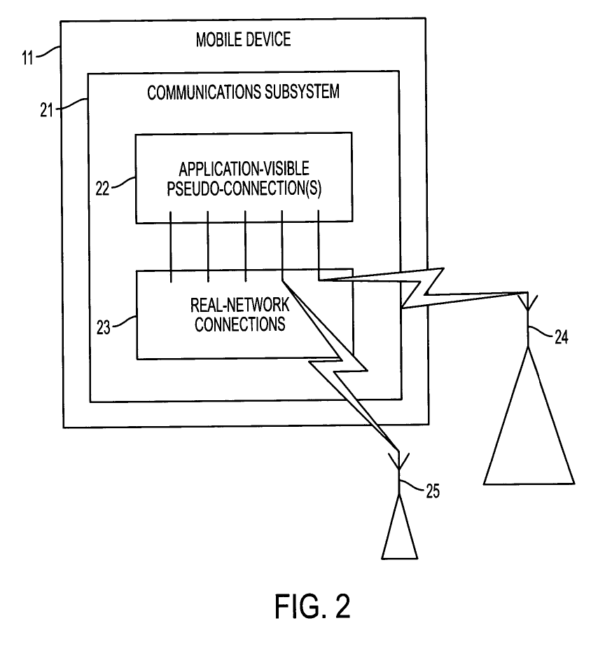

FIG. 2 shows a conceptual block diagram of how mobile device 11 may be implemented, according to an embodiment of the invention. As shown in FIG. 2, mobile device 11 may include a communications subsystem 21. Communications subsystem 21 may be embodied in hardware, software, firmware, etc., or combinations thereof.

Communications subsystem 21 may perform the role of maintaining one or more connections to one or more applications running on mobile device 11, even while network connectivity is changed. To do so, the communications subsystem 21 may establish one or more “pseudo-connections” 22 to each application running on mobile device 11. A pseudo-connection 22 may be maintained for at least the duration of an application. In this manner, the application may see a constant connection, without interruption.

The communications subsystem 21 may then connect the pseudo-connections with corresponding real-network connections 23. The real-network connections 23 may be established via physical-layer connections (which are often wireless connections, but which are not limited thereto) to various networks or media within a network. As mobile device 11 is transported through different networks, the communications subsystem 21 may establish real-network connections 23 with each network and may determine, based on some criterion or criteria, which real-network connection 23 should be maintained and connected to a given pseudo-connection 22.

For example, suppose that mobile device 11 is initially located within the service area of network 12. A real-network connection 23 may then be established with a network communications point (e.g., reference numeral 24 in FIG. 2) for network 12, and this real-network connection 23 may be linked to a pseudo-connection 22 corresponding to an application desiring communications. Now, suppose that mobile device 11 is transported toward another network, say, network 13. As mobile device 11 approaches network 13 (e.g., in region 14), the communications subsystem may establish a real-network connection 23 with a network communications point (e.g., reference numeral 25 in FIG. 2) for network 13. The communications subsystem 21 may then arbitrate which connection to maintain and connect to the corresponding pseudo-connection 22 and which one to drop. Alternatively, the communications subsystem 21 may maintain multiple real-network connections 23 at a given time for a given application (and pseudo-connection 22), only one of which may be linked to the given application (pseudo-connection 22) at a time. Such an arrangement may be advantageous, for example, in a place like region 14, where networks overlap, and where it may be beneficial to alternate network connections or to maintain concurrent network connections.

The communication subsystem 21 may use various criteria to arbitrate between or among more than one real-network connections 23 to determine which one to link to a particular pseudo-connection 22. Criteria for determining which real-network connection 23 to utilize at a given time may include, but are not limited to, for example, speed, latency, quality of service, cost, or other criteria, or combinations thereof, which may be selectable, for example, by a user, designer, operator, etc.

The communications subsystem 21, according to an exemplary implementation of the invention, may be able to receive information from each network (or medium) to which it is connected, via real-network connections 23. Such information may be used to arbitrate among different real-network connections 23, as discussed above. For example, the networks may provide information regarding latencies, speeds, costs, etc., on which the communications subsystem may base its decision(s). In some embodiments, this may be implemented using a request procedure (i.e., where mobile device 11 may request such information), or it may be implemented as an automatic feature of the networks and the mobile device 11.

Communications subsystem 21 may additionally perform security-related functions. Such security-related functions may deal with authentication and privacy aspects of the connections. Such functions may include, but are not limited to, encryption/decryption, login procedures, and the like.

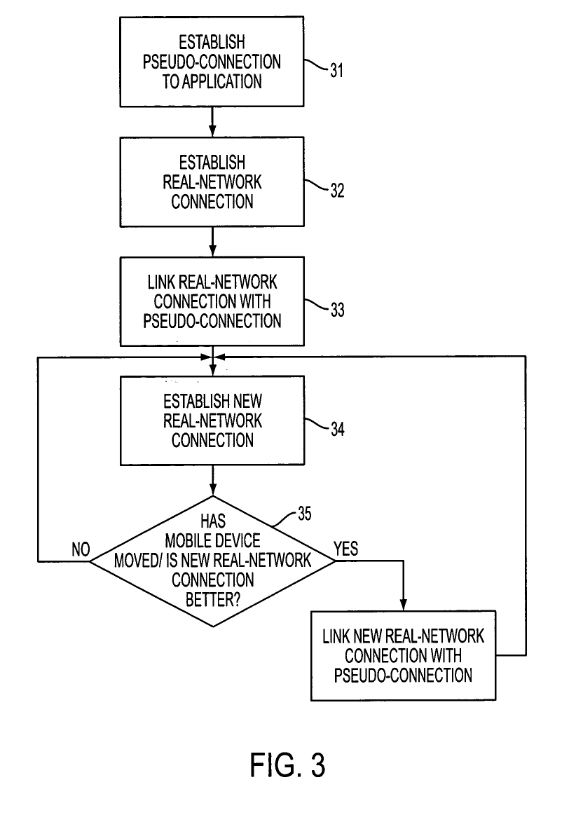

Operation of the mobile device 11 will now be described in connection with the flowchart of FIG. 3, which illustrates a process that may occur when the mobile device 11 switches networks and/or media within a network. First, in Block 31, the communications subsystem 21 may establish a pseudo-connection 22 to an application. The pseudo-connection 22 may be established immediately upon commencement of the application, or it may be established pursuant to a request for communications by the application. In either case, the pseudo-connection 22 may be maintained for at least the duration of the application, once it has been established.

After establishing the pseudo-connection 22, the communications subsystem 21, in Block 32, may establish a real-network connection 23 to a network via which communications with a desired destination device 18 may be established.

Next, in Block 33, the communications subsystem 21 may link the pseudo-connection 22 with the real-network connection 23, thus establishing a connection between the application and the destination device 18.

It is possible, however, that the mobile device 11 may be transported, and it is also possible that, even where the mobile device 11 is not transported, multiple means for connectivity with the destination device 18 may be supported. As examples of such multiple means for connectivity, the same location may be serviced by two networks, or a given network servicing the location may have more than one medium available (e.g., a satellite link and a microwave link); other such multiple means for connectivity may be possible, and the invention is not to be understood as being limited to these examples. In such cases, the communications subsystem 21 may be responsible for arbitrating between or among the various possible connections. Such arbitration may include the maintenance and/or usage of more than one concurrent connection.

In this vein, continuing with the flowchart of FIG. 3, in Block 34, another possible network connection may be detected, and a second real-network connection 23 may then be established. Thus, the mobile device 11 may have established connections with two networks or media.

In Block 35, the communications subsystem 21 may determine whether the new real-network connection 23 is better than the previously-established real-network connection (established in Block 32). If so, then the new real-network connection 23 may be linked to the pseudo-connection 22. Otherwise, the original connectivity may be maintained. This process may repeat, as shown in the flowchart, as a mobile device 11 is transported or if other media become available (or newly unavailable) at the given location of the mobile device 11.

As discussed above, the determination of which network provides better performance may be based, for example, on one or more criteria, which may include, but are not limited to, speed, latency, cost, quality of service, and combinations thereof. The communications subsystem 21 may receive information related to such performance-related quantities from one or more networks or media. This process may involve the mobile device 11 sending a query to each network/medium and receiving the information in response.

As discussed above, connections may be of many types. Connectivity may be via, for example, Internet protocol (IP) sockets, remote procedure calls (RPC), universal datagram protocol (UDP), transport control protocol (TCP), instant messaging (IM), or any other means by which applications connect with operating systems.

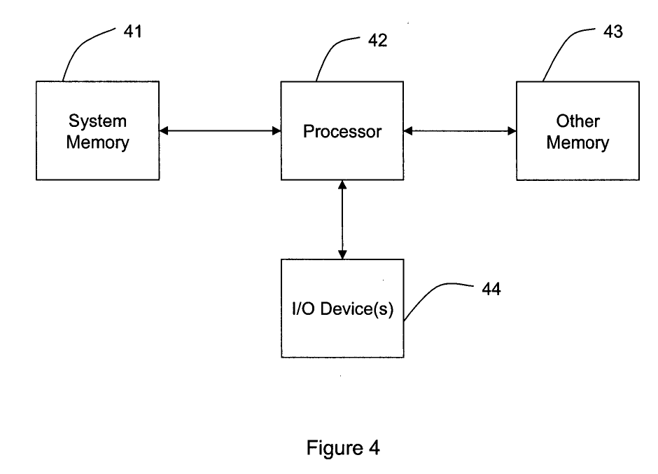

Some embodiments of the invention, as discussed above, may be embodied in the form of software instructions on a machine-readable medium. Such an embodiment is illustrated in FIG. 4. The computer system of FIG. 4 may include at least one processor 42, with associated system memory 41, which may store, for example, operating system software and the like. The system may further include additional memory 43, which may, for example, include software instructions to perform various applications. The system may also include one or more input/output (I/O) devices 44, for example (but not limited to), keyboard, mouse, trackball, printer, display, network connection, etc. The present invention may be embodied as software instructions that may be stored in system memory 41 or in additional memory 43. Such software instructions may also be stored in removable media (for example (but not limited to), compact disks, floppy disks, etc.), which may be read through an I/O device 43 (for example, but not limited to, a floppy disk drive). Furthermore, the software instructions may also be transmitted to the computer system via an I/O device 43, for example, a network connection; in this case, the signal containing the software instructions may be considered to be a machine-readable medium.

The invention has been described in detail with respect to preferred embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

1. A machine-readable medium that provides instructions, which when executed by a computing platform, cause said computing platform to perform operations comprising a method of:
maintaining at least one pseudo-connection to the application for at least a duration of an application being run on a mobile device and communicating with a destination device;
establishing a first real-network connection between the mobile device and a first network through which the mobile device may communicate with the destination device; and
coupling the pseudo-connection to the first real-network connection.

2. The machine-readable medium according to claim 1, further comprising instructions, which when executed by said computing platform, cause said computing platform to perform further operations comprising:
establishing a second real-network connection between the mobile device and a second network through which the mobile device may communicate with the destination device;
determining whether the first network or the second network better meets at least one selected criterion; and
decoupling the pseudo-connection from the first real-network connection and coupling the pseudo-connection to the second real-network connection if the second network meets said at least one selected criterion.

3. The machine-readable medium according to claim 2, further comprising instructions, which when executed by said computing platform, cause said computing platform to perform further operations comprising:
maintaining more than one real-network connection at a given time.

4. The machine-readable medium according to claim 2, wherein said determining is based on at least one of: speed, latency, cost, and quality of service.

5. The machine-readable medium according to claim 2, further comprising instructions, which when executed by said computing platform, cause said computing platform to perform further operations comprising:
receiving performance-related information from at least one of the first network and the second network.

6. The machine-readable medium according to claim 5, further comprising instructions, which when executed by said computing platform, cause said computing platform to perform further operations comprising:
querying at least one of the first network and the second network for the performance-related information.

7. The machine-readable medium of claim 1, wherein said establishing a first real-network connection comprises:
performing security-related functions.

8. A mobile device comprising:
a computing platform; and
at least one machine-readable medium according to claim 1.

9. A method, comprising:
maintaining at least one pseudo-connection to the application for at least a duration of an application being run on a mobile device and communicating with a destination device;
establishing a first real-network connection between the mobile device and a first network through which the mobile device may communicate with the destination device; and
coupling the pseudo-connection to the first real-network connection.

10. The method of claim 9, further comprising:
establishing a second real-network connection between the mobile device and a second network through which the mobile device may communicate with the destination device;
determining whether the first network or the second network better meets at least one selected criterion; and
decoupling the pseudo-connection from the first real-network connection and coupling the pseudo-connection to the second real-network connection if the second network meets said at least one selected criterion.

11. The method of claim 10, further comprising:
maintaining more than one real-network connection at a given time.

12. The method of claim 10, further comprising:
receiving performance-related information from at least one of the first network and the second network.

13. The method of claim 10, wherein said establishing a first real-network connection comprises:
performing security-related functions.

14. A system, comprising:
a communications subsystem, the communications subsystem comprising:
at least one pseudo-connection to the at least one application, the at least one pseudo-connection to the at least one application to be maintained for at least the duration of the at least one application; and
at least one real-network connection to at least one network communication point corresponding to at least one network adapted to facilitate communication between the apparatus and a destination device,
wherein the communications subsystem is adapted to couple a real-network connection to a pseudo-connection.

15. The system according to claim 14, wherein the communications subsystem further includes capability to switch the at least one real-network connection to which a given pseudo-connection is coupled substantially without interrupting the pseudo-connection.

16. The system according to claim 15, wherein the communications subsystem is adapted to base a decision to switch the at least one real-network connection on the relative performances with respect to at least one selected criterion of the at least one network with which the at least one real-network connection is established.

17. The system according to claim 16, wherein the at least one selected criterion comprises at least one of: speed, latency, cost, and quality of service.

18. The system according to claim 16, wherein the communications subsystem is adapted to receive performance-related information from at least one network.

19. The system according to claim 18, wherein the communications subsystem is adapted to query said at least one network for the performance-related information.

20. The system according to claim 14, wherein the communications subsystem is further adapted to interact with the at least one network to perform security-related functions.
